(19) United States
(12) Patent Application Publication
(10) Pub. No.: US 2022/0011009 A1
(43) Pub. Date: Jan. 13, 2022

(54) AIR CLEANER

(71) Applicant: LG ELECTRONICS INC., Seoul (KR)

(72) Inventors: Jongsu Lee, Seoul (KR); Juhyup Yoon, Seoul (KR); Naehyun Park, Seoul (KR); Dongryul Park, Seoul (KR); Yeonghyeon Gim, Seoul (KR)

(21) Appl. No.: 17/371,273

(22) Filed: Jul. 9, 2021

(30) Foreign Application Priority Data
Jul. 10, 2020 (KR) 10-2020-0085470

(51) Int. Cl. F24F 13/08; F24F 8/108; F24F 13/20; F24F 13/28

(52) U.S. Cl. CPC F24F 13/082; F24F 8/108; F24F 2013/205; F24F 13/28; F24F 13/20

(57) ABSTRACT

An air cleaner may include a case having a discharge port formed at an upper side and vertically open; a blower fan disposed inside of the case, and blowing air inside the case toward the discharge port; a discharge body disposed on an upper side of the case in which the discharge port is formed, and having a discharge passage that guides the air, blown by the blower fan, toward the discharge port; a discharge guider rotatably disposed on an upper side of the discharge body, and having a plurality of grills bent so as to guide air, flowing upward through the discharge passage, in a radially outward direction; and a motor that rotates the discharge guider disposed on the discharge body.

### CROSS-REFERENCE TO RELATED APPLICATION(S)

This application claims priority under 35 U.S.C. § 119 to Korean Application No. 10-2020-0085470 filed in Korea on Jul. 10, 2020, whose entire disclosure is hereby incorporated by reference.

### BACKGROUND

### 1. Field

An air cleaner is disclosed herein.

### 2. Background

An air cleaner is a device that filters air and discharges the filtered air to a room to reduce dust and bacteria in the air of the room. The air cleaner filters out foreign matter by blowing air of a room, and discharges the air, from which the foreign matter has been removed.

Korean Laid-Open Patent Publication No. KR 10-2017-0140578, which is hereby incorporated by reference, discloses an air cleaner which is vertically disposed to filter a large amount of air. In the air cleaner disclosed in the related art, an air cleaner disposed at a lower position may uniformly discharge air, purified through an annular air passage, in a radial direction. In this case, the purified air may be discharged in a direction toward wall surfaces or corners of a room, in addition to a direction into the room.

If an air flow is discharged uniformly in all directions, the purified air may be discharged to a space requiring no purification, depending on an arrangement of the air cleaner. Accordingly, it is required to control a wind or airflow direction of air discharged from an air cleaner disposed at a lower position.

### BRIEF DESCRIPTION OF THE DRAWINGS

Embodiments will be described in detail with reference to the following drawings in which like reference numerals refer to like elements, and wherein:

FIG. 1 is a perspective view of an air cleaner according to an embodiment;

FIG. 2 is a cross-sectional view of an air cleaner according to an embodiment;

FIG. 3 is a perspective view of a discharge body, a discharge guider, and a portion of a divider which are coupled to each other, according to an embodiment;

FIG. 4 is a cross-sectional view of a discharge body, a discharge guider, and a divider which are coupled to each other, according to an embodiment;

FIG. 5 is a perspective view of a discharge body according to an embodiment;

FIG. 6 is a perspective view of a discharge guider according to an embodiment;

FIG. 7 is a perspective view of another side of the discharge guider according to an embodiment;

FIG. 8 is a bottom view for explaining an arrangement of a discharge guider, a motor, and a gear according to an embodiment;

FIG. 9 is a plan view of a discharge guider according to an embodiment;

FIG. 10 is a perspective view of a discharge guider according to another embodiment;

FIG. 11 is a perspective view of a discharge guider and a discharge body according to yet another embodiment;

FIG. 12 is a perspective view of a discharge guider and a discharge body according to still another embodiment;

FIG. 13A is a diagram illustrating a shape and an arrangement of a plurality of grills of a discharge guider according to an embodiment;

FIG. 13B is a cross-sectional view of a plurality of grills of a discharge guider according to an embodiment;

FIG. 13C is a cross-sectional view of a plurality of grills of a discharge guider according to another embodiment;

FIGS. 14A-C are diagrams illustrating data indicative of a flow of an air cleaner having no discharge guider, in which FIG. 14A is a 3D view of a flow as seen from a top when a first blower and a second blower are in operation, FIG. 14B is a 3D view of a flow as seen from a side when a first blower and a second blower are in operation, and FIG. 14C is a view of a wind direction and a wind speed as seen from the side when a first blower and a second blower are in operation; and

FIGS. 15A-15C are diagrams illustrating data indicative of a flow of an air cleaner having a discharge guider according to embodiments, in which FIG. 15A is a 3D view of a flow as seen from a top when a first blower and a second blower are in operation, FIG. 15B is a 3D view of a flow as seen from a side when a first blower and a second blower are in operation, and FIG. 15C is a view of a wind direction and a wind speed as seen from the side when a first blower and a second blower are in operation.

### DETAILED DESCRIPTION

Advantages and features of embodiments and methods of accomplishing the same will be more clearly understood from exemplary embodiments described below with reference to the accompanying drawings. However, the embodiments are not limited to the disclosed embodiments but may be implemented in various different forms. The embodiments are provided only to complete disclosure and to fully provide a person having ordinary skill in the art to which the embodiments pertain, and the embodiments will be defined by the scope of the appended claims. Wherever possible, like reference numerals generally denote like elements throughout the specification.

Hereinafter, embodiments will be described with reference to the accompanying drawings for explaining an air cleaner.

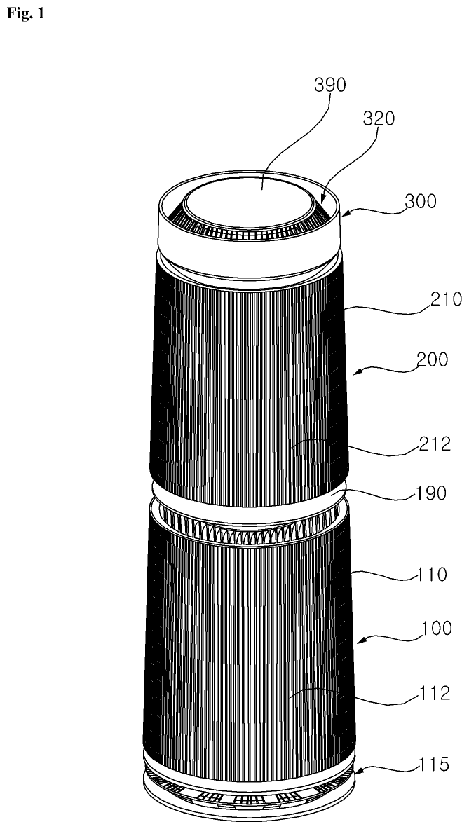

Referring to FIG. 1, an air cleaner 10 according to an embodiment may include blowers 100 and 200 that generate an air flow, and a circulator 300 that changes a discharge direction of the air flow generated by the blowers 100 and 200. The blowers 100 and 200 may include first blower 100 that generates a first air flow, and a second air blower 200 that generates a second air flow.

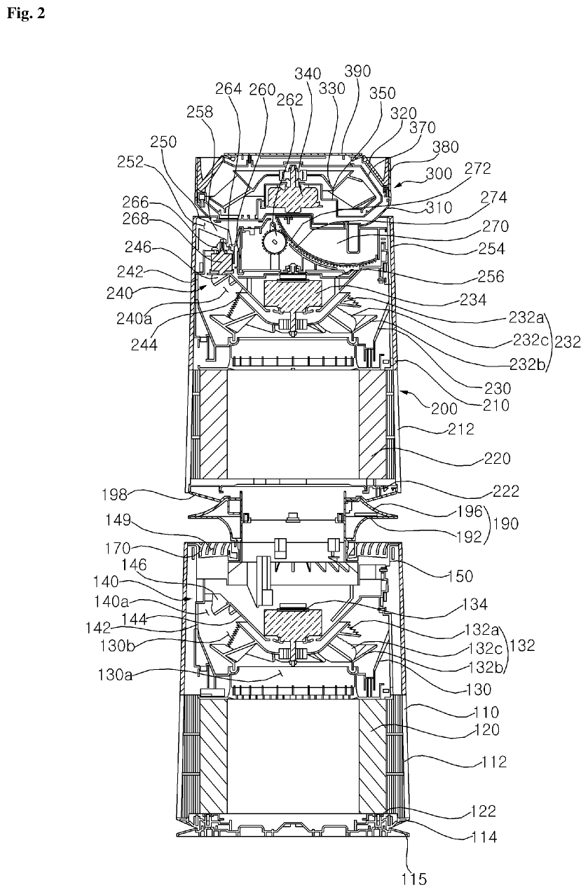

Referring to FIGS. 1 and 2, the first blower 100 and the second blower 200 may be disposed vertically. The second blower 200 may be disposed over the first blower 100.

The air cleaner 10 may include cases 110 and 210 that form an exterior thereof. The cases 110 and 210 may include first case 110 that form an exterior of the first blower 100, and a second case 210 that forms an exterior of the second blower 200.

The first case 110 may have a cylindrical shape. An upper portion of the first case 110 may have a diameter which is smaller than a diameter of a lower portion thereof.

The first case 110 may have a first suction port 112, through which air is suctioned. The first suction port 112 may allow an inside and outside of the first case 110 to communicate with each other. A plurality of first suction ports 112 may be formed. The first case 110 may have the plurality of first suction ports 112 formed on a circumference thereof and may have a first discharge port 149 which is open upward.

The plurality of first suction ports 112 may be elongated vertically. The plurality of first suction ports 112 may be formed evenly in a circumferential direction along an outer circumference of the first case 110, so that air may be suctioned in any direction relative to the first case 110. As described above, the first case 110 may have a cylindrical shape, and the plurality of first suction ports 112 may be formed along the outer circumference of the first case 110, such that an air suction amount may increase.

Referring to FIG. 2, a discharge guider 170, rotatably disposed in the first discharge port 149 which is open upward, and changing a wind or airflow direction of air flowing upward, may be provided on or at an upper side of the first blower 100. The first discharge port 149 having an annular shape may be formed on the first case 110. A discharge body 150 having a discharge passage 150a that guides air, blown upward by a first fan 132, to flow upward, and the discharge guider 170 rotatably disposed in the discharge body 150 and changing a direction of air which is discharged upward, may be disposed on the first case 110.

A first filter 120 may be removably mounted in a mounting space. The first filter 120 may have a cylindrical shape, and air may be introduced through an outer circumferential surface of the first filter 120. Impurities, such as fine dust contained in the air, may be filtered out while the air passes through the first filter 120. If the first filter 120 has a cylindrical shape, air may be introduced in any direction relative to the first filter 120, thereby increasing an air filtering area.

The mounting space may be formed in a cylindrical shape corresponding to the shape of the first filter 120. While being mounted, the first filter 120 may be slidably inserted into the mounting space. By contrast, while being removed, the first filter 120 may be slidably withdrawn from the mounting space.

The first blower 100 may include a first fan housing 130 disposed above the first filter 120, the first fan 132 rotatably disposed inside the first fan housing 130, and a first fan motor 134 that rotates the first fan 132. The first fan housing 130 has a first housing suction hole 130a having a circular shape and formed at a lower portion thereof, and a first housing discharge hole 130b having a ring shape and formed at an upper portion thereof. The first fan 132 may suction air in an axial direction and discharge the air upwardly in a radial direction.

The first fan 132 may include a first hub 132a, to which a rotational shaft of the first fan motor 132 as a centrifugal fan motor may be coupled; a first shroud 132b spaced apart from the first hub 132a; and a plurality of first blades 132c disposed between the first hub 132a and the first shroud 132b. The first fan motor 134 may be coupled to an upper portion of the first fan 132.

The first blower 100 may further include a first blowing guider 140 coupled to an upper portion of the first fan 132, and that guides the air, having passed through the first fan 132, to flow upward. The first blowing guider 140 may have an annular first air-blowing passage 140a, through which the air discharged from the first fan 132 may flow. The first blowing guider 140 may include a first blower body 142 having a cylindrical shape and forming an exterior thereof; a bowl-shaped first motor cover 144 which may be disposed at a center portion of the first blower body 142 and into which the first fan motor 134 may be inserted; and a plurality of first guide vanes 146 which may be spaced apart from each other in a circumferential direction in the first air-blowing passage 140a disposed between the first blower body 142 and the first motor cover 144.

The first blowing guider 140 has the annular first air-blowing passage 140a which is formed between the first blower body 142 and the first motor cover 144, and through which the air discharged from the first fan 132 flows. The plurality of first guide vanes 146 may guide air, discharged from the first fan 132 to the first air-blowing passage 140a, to flow upward. The respective first guide vanes 146 may be formed in a bent plate shape disposed in an upright position close to a vertical direction. The first guide vanes 146 may extend from an outer circumferential surface of the first motor cover 144 to an inner circumferential surface of the first blower body 142. The plurality of first guide vanes 146 may be spaced apart from each other. The plurality of first guide vanes 146 may guide air, introduced into the first air-blowing passage 140a of the first blowing guider 140 after passing through the first fan 132, to flow upward.

The first fan motor 134 may be supported on an upper side of the first motor cover 144. Further, a rotational shaft of the first fan motor 134 may extend downwardly from the first fan motor 134 and may pass through a bottom surface of the first motor cover 144 to be coupled to the first hub 132a.

The first blower 100 may further include a base 115 provided under the lower case 110 and configured to be placed on an installation surface or on the ground. The base 115 may be spaced apart downwardly from a lower end of the first case 110. A base suction port 114 may be formed in a separation space between the first case 110 and the base 115.

The air cleaner 10 may include a divider 190 provided between the first blower 100 and the second blower 200. By providing the divider 190, the second blower 200 may be spaced apart upwardly from the first blower 100.

The divider 190 may separate or block an air flow, generated by the first blower 100, from an air flow generated by the second blower 200. By providing the divider 190, the first and second blowers 100 and 200 may be vertically spaced apart from each other.

A separation space, in which the divider 190 may be disposed, may be formed between the first blower 100 and the second blower 200. The divider 190 may include a guide wall 192, and a separation wall 196 disposed above the guide wall 192. The guide wall 192 may extend rounded in an upward direction, and the separation wall 196 may extend rounded in a downward direction. The guide wall 192 may extend upwardly from the discharge body 150. At least a portion of the guide wall 192 may be formed as a curved surface having a predetermined radius of curvature. A printed circuit board (PCB) device (not shown) may be disposed in the divider 190.

The divider 190 may include a lower end fixing wall 194 that extends downwardly from the guide wall 192 and coupled to the discharge body 150. The lower end fixing wall 194 may be coupled to an outer circumference of a fixing body 154 of the discharge body 150, which will be described hereinafter. The lower end fixing wall 194 may be coupled to the discharge body 150, so as to fix an arrangement of the divider 190.

An outer circumference of the lower end fixing wall 194 may contact a first bearing 178 disposed in the discharge guider 170, which will be described hereinafter. A coupling part or portion 195 coupled to the fixing body 154 of the discharge body 150, which will be described hereinafter, may be disposed on an inner circumference of the lower end fixing wall 194. The coupling portion 195 may protrude inwardly from the inner circumference of the lower end fixing wall 194, to pass through a coupling hole 161 of the fixing body 154.

A lower portion 194a of the lower end fixing wall 194 may include a surface that extends parallel to the vertical direction, so as to come into contact with the first bearing 178. An upper portion 194b of the lower end fixing wall 194 may have an inclined surface having a width that increases toward a top in a radially outward direction. The upper portion 194b of the lower rend fixing wall 194 may come into contact with an upper surface of the first bearing 178, thereby restricting an upward movement of the discharge guider 170.

The upper portion 194b of the lower end fixing wall 194 may have a protruding rib (not shown) configured to contact a stopper 179 of the discharge guider 170, which will be described hereinafter, and restrict a rotational range of the discharge guider 170.

The discharge body 150 of the first blower 100 may be disposed under the divider 190, and a support plate 198 of the second blower 200 may be disposed on the divider 190. The support plate 198 may support second filter 220 of the second blower 200. The support plate 198 may have an approximately annular shape. As set forth above, the support plate 198 may be disposed on the separation wall 196. The support plate 198, having an annular shape, may extend from an inner circumference to an outer circumference and be slightly upwardly inclined relative to the axial direction.

The second case 210 may have a cylindrical shape. An upper portion of the second case 210 may have a diameter which is smaller than a diameter of a lower portion thereof. The second case 210 may have a second suction port 212, through which air may be suctioned. The second suction port 212 may be elongated vertically. A plurality of the second suction port 212 may be formed spaced apart from each other in the circumferential direction. The plurality of second suction ports 212 may be formed evenly along an outer circumference of the second case 210 in the circumferential direction, so that air may be suctioned in any direction relative to the second case 210.

The second blower 200 may also include the second filter 220 disposed on second filter frame 222, and the same description of the first filter 120 and the first filter frame 122 may apply to the second filter 220 and the second filter frame 222.

The second blower 200 may include a second fan 232 disposed above the second filter 220 that generates an air flow; a second fan motor 234 that rotates the second fan; and a second fan housing 230 in which the second fan 232 may be disposed. The second fan 232, the second fan motor 234, and the second fan housing 230 may have a same configuration with a similar shape, and may perform a same function, as the first fan 132, the first fan motor 134, and the first fan housing 130 described above. Accordingly, the second fan 232 may be a mixed flow fan, and may include a hub 232a, a shroud 232b, and a plurality of blades 232c, as in the first fan 132.

The second blower 200 may further include a second blowing guider 240 disposed above the second fan 232 that guides air, having passed through the second fan 232, in the upward direction. The second blowing guider 240 may include a second blower body 242 having a cylindrical shape and forming an exterior thereof, and a bowl-shaped second motor cover 244 which is disposed at a center portion of the second blower body 242 and into which the second fan motor 234 may be inserted, and a plurality of second guide vanes 246 spaced apart from each other in the circumferential direction on or in a second air-blowing passage 240a formed between the second blower body 242 and the second motor cover 244. The second blower body 242, the second motor cover 244, and the plurality of second guide vanes 246 may have a same configuration with a similar shape, and may perform a same function, as the first blower body 142, the first motor cover 144, and the plurality of first guide vanes 146 described above.

A second discharge cover 250, having a second discharge port 252 which is open upward, may be disposed at an upper portion of the second blower 200. The second discharge port 252 may have a ring shape. A second discharge grill 258 which may extend radially from the second discharge port 252 may be disposed in the second discharge cover 250.

Referring to FIG. 2, the second discharge cover 250 may have an outer circumferential surface 254 disposed on an upper portion of the second case 210 and forming a cylindrical edge, a guide base 256 disposed inside of the outer circumferential surface 254, and a plurality of the second discharge grill 258 that extends radially from the guide base 256 to the outer circumferential surface 254.

The air cleaner 10 may include a moving guider 260 rotatably disposed on the guide base 256 that supports an arrangement of the circulator 300, and a mover 270 that moves along the moving guider 260 and changes an inclination angle of the circulator 300. The moving guider 260, rotatably disposed on the guide base 256 and supporting the arrangement of the circulator 300, may be disposed on an upper side of the guide base 256. The moving guider 260 may be rotatably disposed on the upper side of the guide base 256, and support the arrangement of the circulator 300.

The guide base 256 may have a disk shape, and the second discharge grill 258 may be disposed around the guide base 256. The moving guider 260 may have a space formed therein, in which a moving gear 262 and a gear motor (not shown) may be disposed.

The mover 270 may be coupled to the circulator 300 and move along the moving guider 260. The mover 270 may change an inclination angle of the circulator 300. The mover 270 may include a guide plate 272 which may be convex toward the moving guider 260. A gear rail 274 engaged with the moving gear 262 may be formed on the guide plate 272.

The mover 270 may be coupled to a lower surface of the circulator 300, thereby partially covering a suction port formed on a lower portion of the circulator 300. That is, the mover 270 partially covers the suction port formed on the lower portion of the circulator 300, thereby reducing a flow amount of air suctioned into the circulator 300.

The moving guider 260 may be rotatably disposed on the guide base 256. The moving guider 260 may be disposed at a center of the guide base 256. The moving guider 260 may rotate about the center of the guide base 256, and may change a direction in which the circulator 300 faces.

A rack gear 264 may be disposed on or at a circumference of one side of the moving guider 260. A pinion gear 266, rotated by being engaged with the rack gear 264, and a motor 268 that drives the pinion gear 266 may be disposed on or at one side of the second discharge grill 258. The pinion gear 266 and the motor 268 may be disposed on a portion of an area in which the plurality of second discharge grills 258 is disposed.

The second filter 220 may have a cylindrical shape with an open top and bottom. The second blower 200 may further include the second filter frame 222 that forms a mounting space for the second filter 220.

The circulator 300 may be disposed on an upper side of the second blower 200. The circulator 300 may control a wind or airflow direction of air discharged upward from the second wind blower 200. The circulator 300 may be disposed parallel or inclined to a plane formed by the second discharge port 252.

The circulator 300 may have a suction port and a discharge port, and may cause filtered air, which is discharged from the second blower 200, to flow a long distance. As set forth above, the circulator 300 may be disposed on the upper side of the second blower 200. An arrangement of the circulator 300 may be changed on the upper side of the second blower 200, and may cause the air, discharged upward by the second blower 200, to flow in the radial direction.

Referring to FIG. 2, the circulator 300 may include a lower cover 310 that forms the suction port; an upper cover 320 that forms the discharge port; a blower fan 330 disposed between the lower cover 310 and the upper cover 320 and that generates an air flow by rotation; a motor 340 disposed between the blower fan 330 and the lower cover 310, that rotates the blower fan 330; and a motor cover 350 disposed under the blower fan 330 and around the motor 340. Referring to FIG. 2, the circulator 300 may further include a supporter 370 disposed between the upper cover 320 and the blower fan 330, that supports the upper cover 320; an outer cover 380 that covers an outside of the upper cover 320; and a display 390 disposed over the supporter 370 that displays an operation or status of the air cleaner 10.

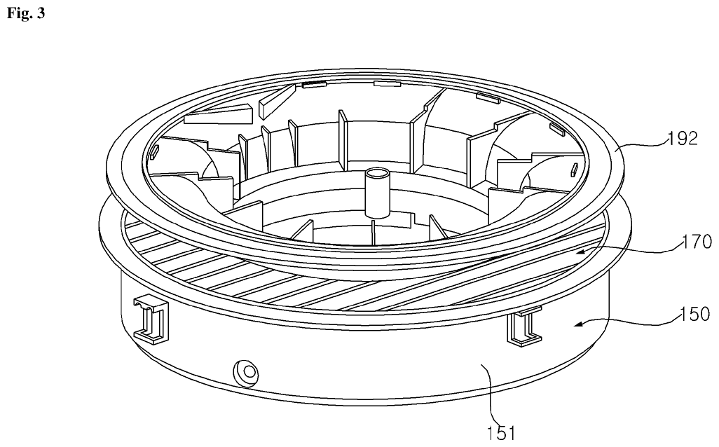

Hereinafter, the discharge body 150, the discharge guider 170, and related components thereof will be described with reference to FIGS. 3 to 13C.

The discharge body 150 may be disposed on an open top of the first case 110. The discharge body 150 may be disposed inside of the first case 110. The discharge body 150 may be disposed above the first blowing guider 140 to guide air, flowing upward due to the first blowing guider 140, in the upward direction. The discharge body 150 may be disposed at the first discharge port 149 of the first case 110, to guide air flowing upward due to the first fan 132.

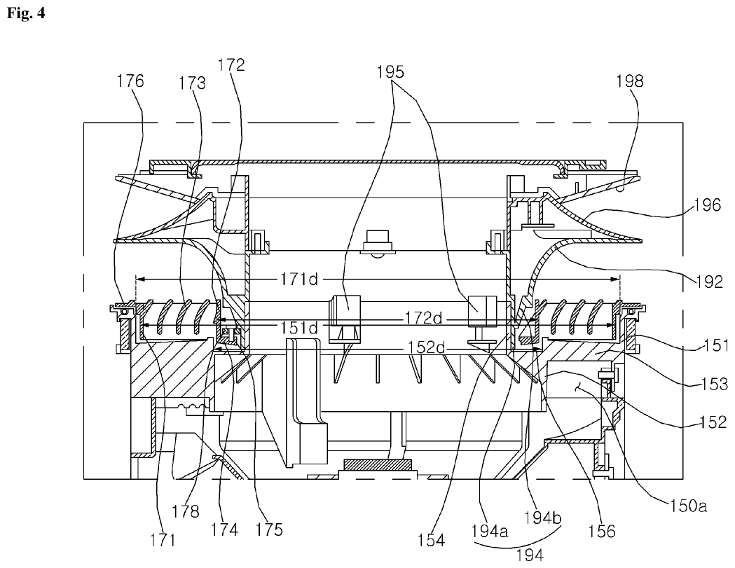

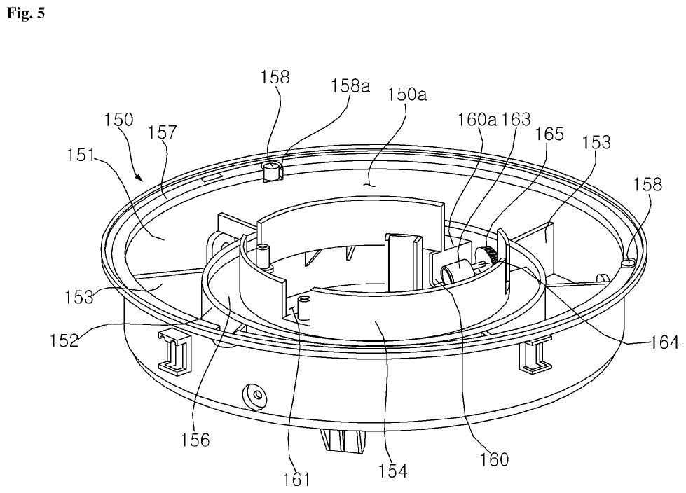

Referring to FIGS. 4 and 5, the discharge body 150 has the annular discharge passage 150a that allows air, blown upward by the first fan 132, to flow upward. The discharge body 150 may include outer body 151 and an inner body 152 which form the discharge passage 150a.

Referring to FIG. 5, the outer body 151 may have a cylindrical shape and form an outer circumference of the discharge passage 150a. The outer body 151 may be coupled to an inner circumferential surface of the first case 110 to be fixed thereto. The inner body 152 may be spaced apart radially inwardly from the outer body 151. The inner body 152 may have a cylindrical shape and form an inner circumference of the discharge passage 150a.

Referring to FIG. 5, the discharge body 150 may include a mounting part or portion or mount 157 that extends radially outwardly from an upper end of the outer body 151. A portion of the discharge guider 170 may be disposed on an upper side of the mounting portion 157. An upper plate 176 of the discharge guider 170, which will be described hereinafter, may be disposed on the upper side of the mounting portion 157. An outer circumferential end of the mounting portion 157 may protrude upward so as to prevent the discharge guider 170 from moving outside of the rotational range.

The mounting portion 157 may have a bearing groove 158a, in which the second bearing 158 configured to contact the discharge guider 170 may be disposed. The bearing groove 158a may be recessed downwardly from the mounting portion 157. The second bearing 158 may be disposed in the bearing groove 158a formed on the mounting portion 157. The bearing groove 158a may be opened radially inwardly from an upper end of the outer body 151.

Referring to FIG. 5, there may be a plurality of the second bearing 158 spaced apart from each other in the circumferential direction. For example, three second bearings 158, which are spaced apart from each other at intervals of 120 degrees, may be disposed in the mounting portion 157.

The second bearings 158 may be configured to contact an outer surface of an outer circumferential wall 171 of the discharge guider 170 which will be described hereinafter. The second bearings 158 allow the discharge guider 170, rotatably disposed inside of the discharge body 150, to rotate stably.

The inner body 152 may have a smaller radius than that of the outer body 151. The discharge passage 150a having an annular shape may be formed between the outer body 151 and the inner body 152. An upper end of the inner body 152 may be disposed below an upper end of the outer body 151. The discharge guider 170 may be disposed on an upper side of the inner body 152.

Referring to FIG. 4, a diameter of an inner circumference of the inner body 152 may be greater than a diameter of an outer circumference of an inner circumferential wall 172. The upper end of the inner body 152 may be disposed above a lower end of the inner circumferential wall 172 of a discharge grill 173.

Referring to FIG. 5, a plurality of ribs 153 may be disposed between the inner body 152 and the outer body 151. The plurality of ribs 153 may connect the inner body 152 and the outer body 151, such that the inner body 152 and the outer body 151 may support each other.

The plurality of ribs 153 may include a vertically extending structure, thereby guiding air flowing upward through the discharge passage 150a. The plurality of ribs 153 having the vertically extending structure does not interrupt the flow of air. The respective ribs 153 may extend in the radial direction, or may be disposed inclined relative to the radial direction.

The discharge body 150 may include the fixing body 154 fixed to the divider 190. The fixing body 154 may be fixed to the lower end fixing wall 194 of the divider 190.

Referring to FIG. 4, the fixing body 154 may be spaced apart radially inwardly from the inner body 152. The fixing body 154 may extend upward so as to be coupled to a lower portion of the guide wall 192. The fixing body 154 may have a cylindrical shape with a smaller radius than that of the inner body 152. An upper end of the fixing body 154 may be disposed above the upper end of the inner body 152.

Referring to FIGS. 4 and 5, the discharge body 150 may include a connection plate 156 disposed between the fixing body 154 and the inner body 152 and that connects the fixing body 154 and the inner body 152. The connection plate 156 may be disposed below the upper end of the inner body 152. A lower plate 174 of the discharge guider 170, which will be described hereinafter, may be disposed on an upper side of the connection plate 156.

A motor 163 may be fixedly disposed in the discharge body 150. A gear 165, rotated while being coupled to the motor 163, may be disposed in the discharge body 150. The gear 165 may be configured to be engaged with a guide rail 175 of the discharge guider 170, which will be described hereinafter.

Referring to FIG. 5, the discharge body 150 may include a motor sheet 160, on which the motor 163 may be disposed. The motor sheet 160 may be disposed inside of the fixing body 154. The fixing body 154 may have a gear hole 160a, which may be formed at a portion at which the motor sheet 160 is disposed, and through which a motor shaft 164 that extends from the motor 163 and coupled to the gear 165 passes. The motor 163 and the gear 165 are provided for rotating the discharge guider 170, and may be mounted in the discharge guider 170 in addition to the discharge body 150.

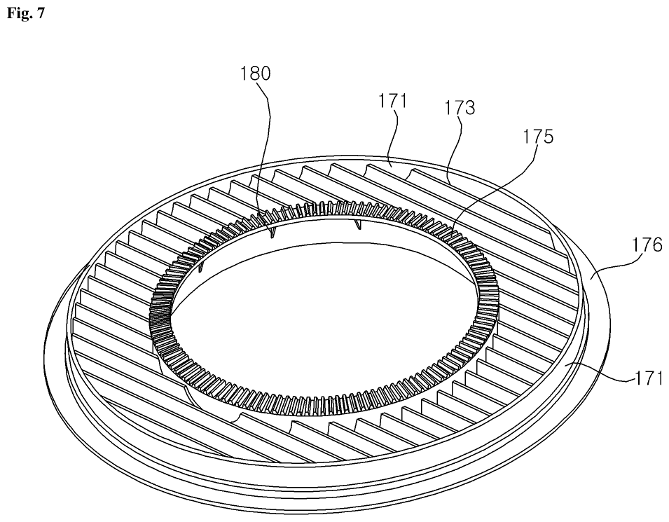

Referring to FIG. 8, the gear 165 may be a bevel gear which corresponds to the guide rail 175 formed in a ring shape on a lower surface of the discharge guider 170. The gear 165 may be disposed at a bottom of the discharge guider 170 and be engaged with the guide rail 175. The bevel gear rotates about a rotational axis perpendicular to a rotational axis of the discharge guider 170, and has a conical shape.

The discharge guider 170 may change a wind or flow direction of air flowing upward through the discharge passage 150a. The discharge guider 170 may cause the air, flowing upward, to flow in a radially upward direction. The discharge guider 170 may be rotatably disposed in the discharge body 150. By the rotation of the discharge guider 170, a flow direction of air flowing radially upwardly may be changed by the discharge guider 170.

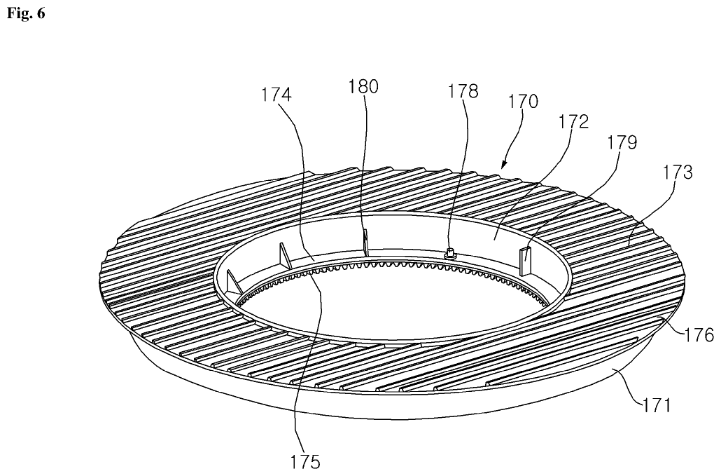

Referring to FIGS. 6 and 7, the discharge guider 170 may include a plurality of discharge grills 173 for changing a wind direction of upwardly flowing air. The plurality of discharge grills 173 may be spaced apart from each other in a direction perpendicular the vertical direction. The plurality of discharge grills 173 may be spaced apart from each other at equal intervals 173d.

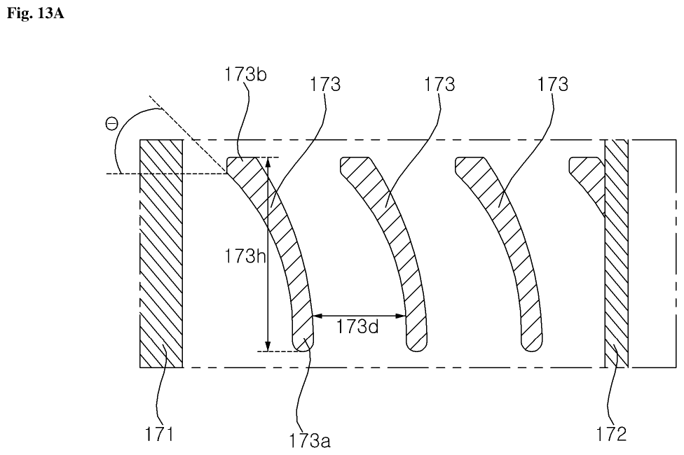

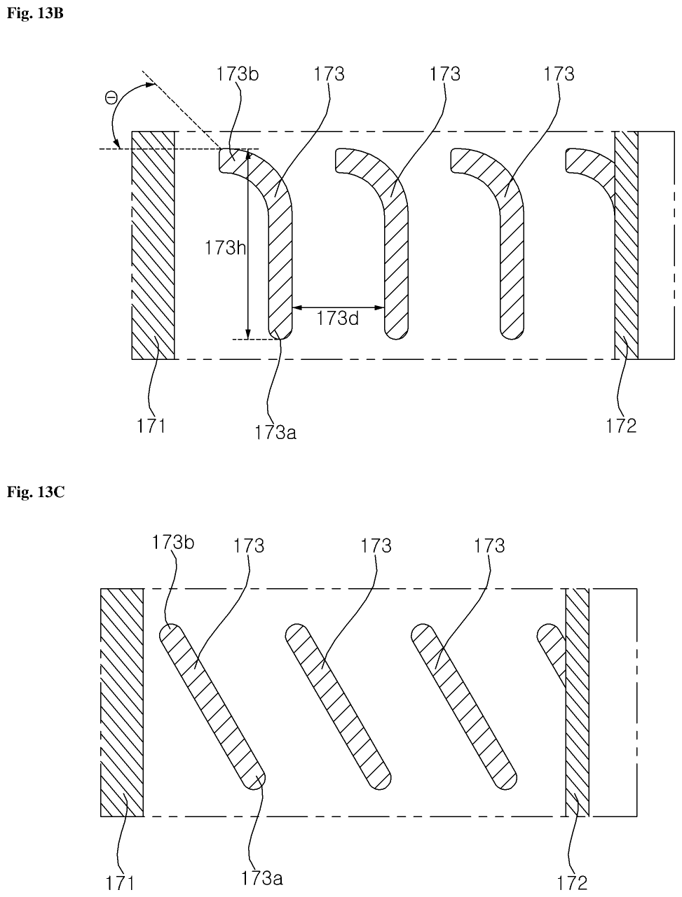

Referring to FIG. 13A, the respective discharge grills 173 may be bent to one side in the direction in which the plurality of discharge grills 173 are spaced apart from each other. The respective discharge grills 173 may be bent in a same direction. The plurality of discharge grills 173 may allow air, flowing upward through the discharge passage 150a, to be discharged in one direction.

Referring to FIG. 13A, the respective discharge grills 173 may be disposed so that a leading edge 173a formed at a lower end is directed downwardly, and a trailing edge 173b formed at an upper end is direction upwardly. A height 173h of the respective discharge grills 173 formed in the vertical direction may be greater than the interval 173d, at which the plurality of discharge grills 173 are spaced apart from each other. The interval 173d, at which the plurality of discharge grills 173 are spaced apart from each other, may be 0.6 to 1 times the height 173h of the respective discharge grills 173 formed in the vertical direction.

Referring to FIG. 13A, the respective discharge grills 173 may be spaced apart from each other at equal intervals. A discharge angle θ, formed by the trailing edge 173b of the respective discharge grills 173, may be an acute angle. The discharge angle θ, formed by the trailing edge 173b of the respective discharge grills 173, may refer to an angle formed between a virtual straight line, parallel to a direction in which the plurality of discharge grills 173 is disposed, and a virtual straight line that extends from an end portion or end of the trailing edge 173b.

The discharge angle θ, formed by the trailing edge 173b of the respective discharge grills 173, may be in a range of 15 degrees to 30 degrees. The discharge angle θ, formed by the trailing edge 173b of the respective discharge grills 173, may be in a range of degrees being 25 to 30 times a ratio (173d/173h) of the interval 173d, at which the plurality of discharge grills 173 is spaced apart from each other, to the height 173h of the respective discharge grills 173 formed in the vertical direction.

A thickness of the respective discharge grills 173 may increase from the leading edge 173a toward the trailing edge 173b. That is, the separation interval 173d of the plurality of discharge grills 173 may decrease from a bottom toward a top.

Referring to FIG. 13A, the plurality of discharge grills 173 according to an embodiment may have a shape which is bent radially outward toward the top.

A shape of the plurality of discharge grills 173 may also be changed to induce air, discharged upwardly, to flow radially outwardly of the blower. Accordingly, as illustrated in FIG. 13B, the plurality of discharge grills 173 may be formed with a lower portion having a straight line portion that extends in the vertical direction, and an upper part bent radially outwardly. Further, as illustrated in FIG. 13C, the plurality of discharge grills 173 may be formed as a straight line surface forming an inclined surface in the radial direction with respect to the vertical direction.

The discharge guider 170 may include the outer circumferential wall 171 forming an outer circumference; the inner circumferential wall 172 spaced apart radially inwardly from the outer circumferential wall 171; and the plurality of discharge grills 173 disposed between the outer circumferential wall 171 and the inner circumferential wall 172, and bent so as to change a wind direction of upwardly flowing air. Referring to FIG. 4, a diameter 171d, formed by the outer circumference of the outer circumferential wall 171 may be smaller than a diameter 151d formed by the inner circumference of the outer body 151.

Referring to FIG. 7, the discharge guider 170 may include the lower plate 174 extending radially inwardly from a lower end of the inner circumferential wall 172, and the upper plate 176 extending radially outwardly from an upper end of the outer circumferential wall 171. The lower plate 174 may be disposed over the connection plate 156 of the discharge body 150. A lower surface of the lower plate 174 may be engaged with the gear 165 coupled to the motor 163. The guide rail 175, configured to be engaged with the gear 165, may be formed on the lower surface of the lower plate 174.

Referring to FIG. 7, the guide rail 175 may be formed on the lower surface of the lower plate 174 having a ring shape. The guide rail 175 may be engaged with the gear 165, and when the gear 165 rotates by operation of the motor 163, the discharge guider 170 may rotate.

The lower plate 174 may be disposed below the lower end of the discharge grill 173. The lower plate 174 may be disposed with a portion thereof, on which the guide rail 175 is formed, being inserted into a space between the inner body 152 and the fixing body 154.

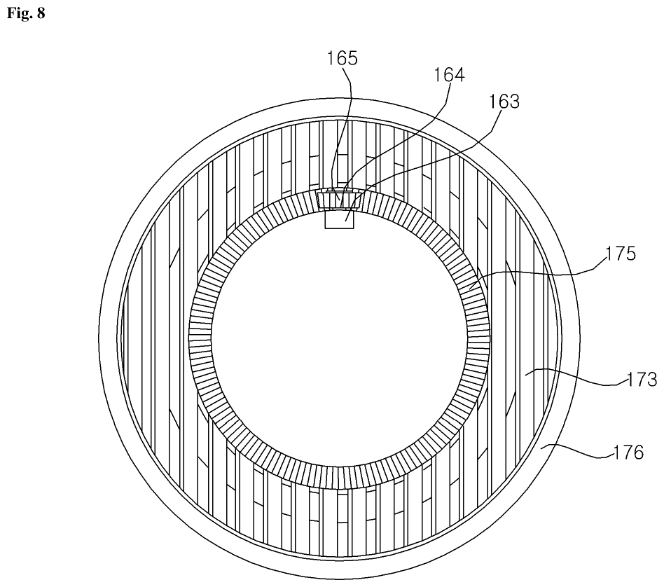

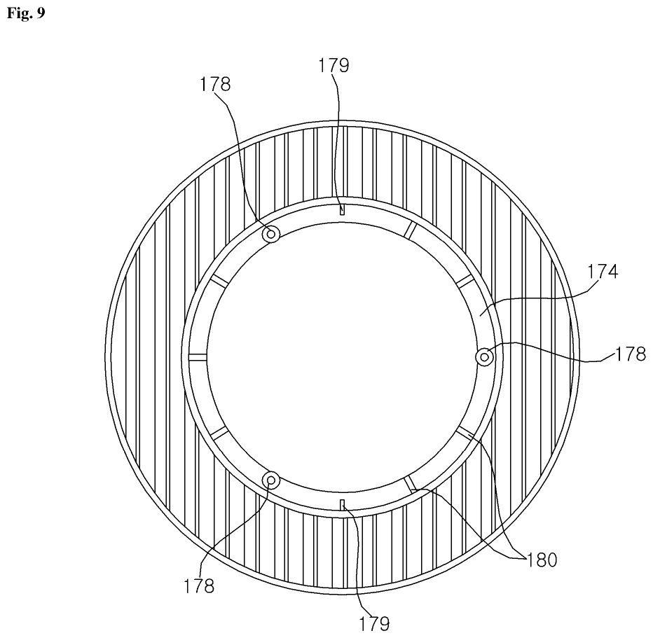

Referring to FIG. 9, the first bearing 178, rotated while in contact with the divider 190 or the discharge body 150, may be disposed on an upper side of the lower plate 174. Referring to FIG. 4, the first bearing 178 may be configured to contact the outer circumference of the lower end fixing wall 194 of the divider 190. A plurality of the first bearing 178 spaced apart from each other in the circumferential direction may be disposed on the upper side of the lower plate 174. For example, referring to FIG. 9, three first bearings 178, which are spaced apart from each other at regular intervals in the circumferential direction, may be disposed on the lower plate 174.

A plurality of vertical ribs 180 provided to reinforce rigidity of the discharge guider 170, may be formed on the upper side of the lower plate 174. The plurality of vertical ribs 180 may be connected to the lower plate 174 and the inner circumferential wall 172, thereby reinforcing the rigidity of the discharge guider 170.

The plurality of vertical ribs 180 may be spaced apart from each other in the circumferential direction on the lower plate 174. The plurality of vertical ribs 180 may have an approximately triangular shape, and connect the lower plate 174 and the inner circumferential wall 172. The vertical ribs 180 may be configured not to come into contact with the upper side of the lower end fixing wall 194.

The stopper 179, protruding upward from the lower plate 174 and coming into contact with a portion of components of the divider 190 to restrict the rotational range of the discharge guider 170, may be disposed on the upper side of the lower plate 174. The stopper 179 may restrict the rotational range of the discharge guider 170. The stopper 179 may come into contact with the protruding rib (not shown) of the lower end fixing wall 194 of the divider 190, to restrict the rotational range of the discharge guider 170.

Referring to FIG. 8, the upper plate 176 may extend radially outwardly from the upper end of the outer circumferential wall 171. An upper surface of the upper plate 176 may have a shape that continuously extends from the discharge grill 173.

Referring to FIGS. 10 to 12, an arrangement of the motor 163 and the guide rail 175 according to another embodiment will be described hereinafter.

Referring to FIG. 10, the guide rail 175 may be formed on the inner circumferential wall 172 of the discharge guider 170. The guide rail 175 may be formed along the inner surface of the inner circumferential wall 172 of the discharge guider 170. In this case, a motor shaft (not shown) that extends from a motor (not shown) may be disposed perpendicular to the discharge body 150. A spur gear may be used as a gear (not shown) coupled to the motor disposed in the discharge body 150.

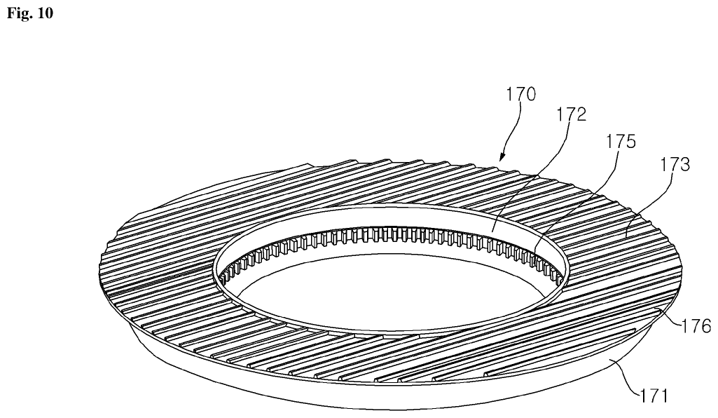

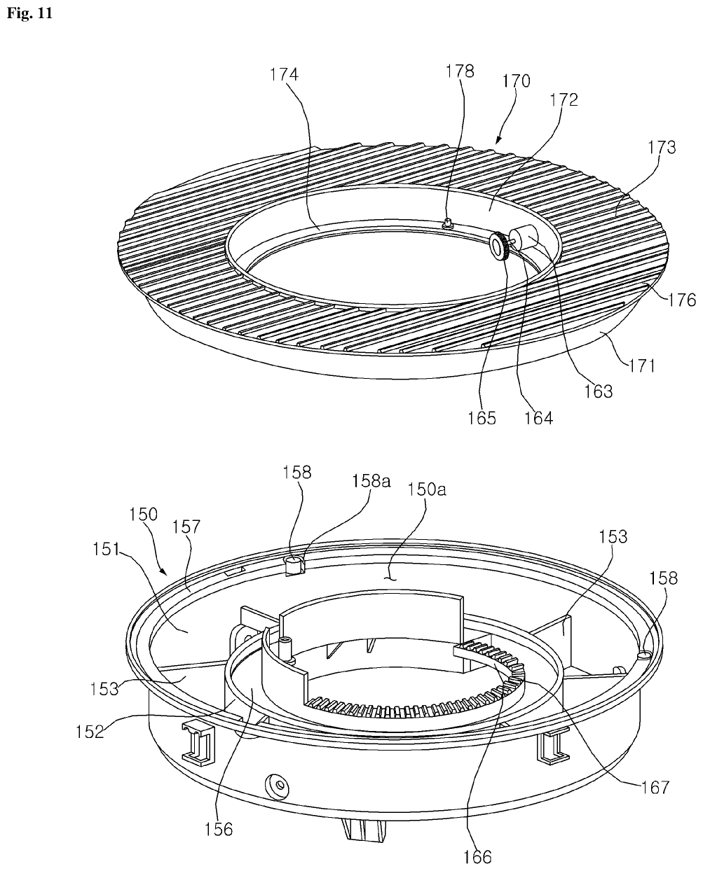

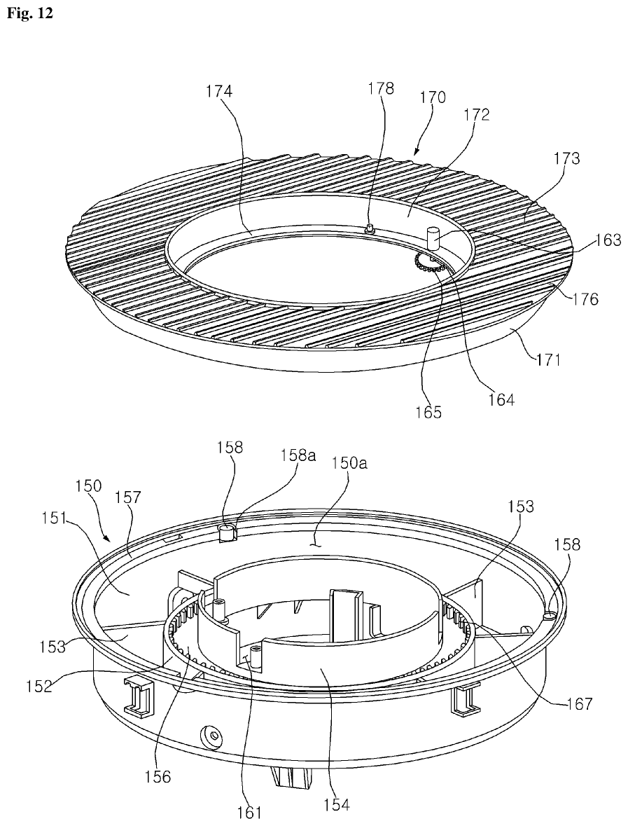

Referring to FIGS. 11 and 12, the motor 163 may be fixedly disposed on the discharge guider 170, and the guide rail 167 may be disposed in the discharge body 150. Referring to FIG. 11, the discharge body 150 may include inner plate 166 that extends inwardly from an inner circumferential end of the connection plate 156. Guide rail 167 may be disposed on an upper surface of the inner plate 166. Referring to FIG. 11, the inner plate 166 may have a semi-ring shape formed at an angle in a range of 180 degrees.

Referring to FIG. 11, the motor 163 may be fixedly disposed on the discharge guider 170. The motor 163 may be fixedly disposed on the upper side of the lower plate 174 of the discharge guider 170. The gear 165 may be a bevel gear coupled to the motor 163. The motor shaft 164, extending from the motor 163, may be directed toward the center of the discharge guider 170.

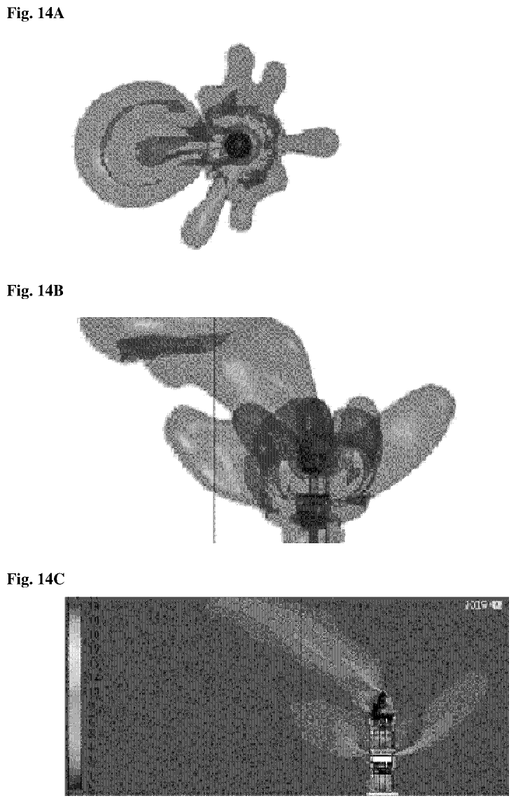

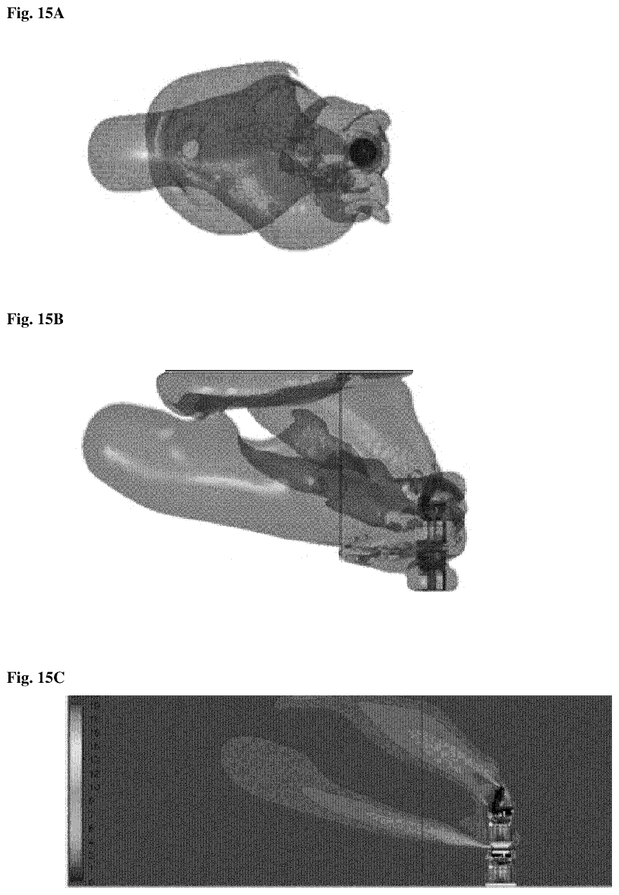

Referring to FIG. 12, the guide rail 167 may be formed on the inner circumference of the inner body 152 of the discharge body 150. The motor 163 may be fixedly disposed on the discharge guider 170, and the motor shaft 164 extending from the motor 163 may extend vertically downwardly from the discharge guider 170. The gear 165 fixed to the motor shaft 164 may be disposed under the discharge guider 170. Referring to FIG. 12, the motor 163 may be fixedly disposed on the upper side of the lower plate 174. The motor shaft 164 extending from the motor 163 may extend downwardly by passing through one side of the lower plate 174. The gear 165 may be coupled to the motor shaft 164 from a bottom of the lower plate 174. With reference to FIGS. 14 and 15, the following description will be given by comparing an air flow of an air cleaner, having a discharge guider which is rotatably disposed according to an embodiments disclosed herein, and an air flow of an air cleaner having no discharge guider, as a comparative example.

Referring to FIGS. 14A-14C, in the air cleaner having no discharge grill, air discharged from the first blower flows in all directions. In this case, a large amount of air may flow into an area in which air purification is not required, such that an amount of air flowing into an area requiring air purification decreases. Further, it can be seen that an amount of air flowing in a desired direction is relatively small, such that air discharged from the first blower 100 may not flow a long distance.

Referring to FIGS. 15A-15C, in the air cleaner having the discharge grill according to embodiments disclosed herein, air discharged from the first blower 100 flows in one direction. In this case, the air discharged from the first blower 100 may flow in the same direction as the air discharged from the second blower 200. A large amount of purified air may be blown to an area requiring air purification, which is desired by a user. That is, as illustrated in FIG. 15C, the air discharged from the first blower 100 may also reach a long distance in one direction.

Embodiments disclosed herein provide an air cleaner for simply controlling a flow direction of discharged air, in which using a simple structure, the air cleaner may change a flow direction of air discharged upward from an annular discharge port. Embodiments disclosed herein further provide an air cleaner in which by intensively discharging air only to a local area, filtered air may flow in a direction desired by a user. Embodiments disclosed herein furthermore provide an air cleaner allowing air, discharged from a first blower disposed at a lower position, to reach a long distance.

Embodiments disclosed herein are not limited to the aforementioned advantages and other advantages not described will be clearly understood by those skilled in the art from the description.

Embodiments disclosed herein provide an air cleaner that may include a case having a discharge port which is formed on an upper side and is vertically open; and a fan disposed inside of the case, and causing air inside the case to flow toward the discharge port, such that the air cleaner may blow the air in an upward direction. The air cleaner may include a discharge body disposed on an upper side of the case in which the discharge port is formed, and having a discharge passage that guides air, blown by the fan, toward the discharge port; a discharge guider rotatably disposed on an upper side of the discharge body, and having a plurality of grills bent so as to guide air, flowing upward through the discharge passage, in a radially outward direction; and a motor that rotates the discharge guider disposed on the discharge body, such that the air cleaner may flow the upwardly flowing air in one direction.

The discharge body may include an outer body forming an exterior thereof, and an inner body disposed radially inwardly from the outer body, and forming an annular discharge passage with the outer body, thereby forming an annular passage for flowing the upwardly discharged air. The plurality of grills may be spaced apart from each other in one direction perpendicular to a vertical direction, and may be bent to one side in the direction in which the plurality of grills is spaced apart from each other, thereby guiding the air discharged through the annular passage in one direction.

The air cleaner may further include a gear that rotates while being coupled to the motor. The motor may be mounted in the discharge body. Further, the discharge guider may include a guide rail disposed inside of the inner body and engaged with the gear, such that a wind direction of the air flowing upward through the annular discharge passage may be controlled, and a flow of the air flowing through the discharge passage may not be interrupted.

The guide rail may be formed in a ring shape on a lower surface of the discharge guider. The gear may be a bevel gear that rotates about a rotational axis perpendicular to a rotational axis of the discharge guider, and has a conical shape, thereby rotating the discharge guider.

The air cleaner may further include a gear that rotates while being coupled to the motor. The motor may be mounted on one side of the discharge guider, and the guide rail engaged with the gear may be formed on one side of the discharge body, such that the motor is disposed on the discharge guider, and the guide rail may be formed on the discharge body, thereby rotating the discharge guider.

The air cleaner may further include a divider disposed on an upper side of the discharge body, and extending radially outwardly from the discharge body toward a top. The discharge body may include a fixing body spaced apart inwardly from the inner body and fixed to the divider.

The discharge body may include a connection plate that connects the fixing body and the inner body. The connection plate may be disposed below an upper end of the inner body, thereby providing a space for mounting the guide rail of the discharge guider.

The discharge guider may include a guide rail formed in a ring shape on a lower surface of the discharge guider and engaged with the gear. The guide rail may be configured to be inserted into a space between the inner body and the fixing body, such that the discharge guider may rotate stably. The discharge body may include a motor sheet disposed inside of the fixing body, and fixing an arrangement of the motor, such that the motor may be fixed to the discharge body to rotate the discharge guider.

The discharge guider may include an outer circumferential wall that forms an outer circumference thereof; an inner circumferential wall spaced apart radially inwardly from the outer circumferential wall; a plurality of discharge grills disposed between the outer circumferential wall and the inner circumferential wall, and bent so as to change a wind direction of upwardly flowing air; and a lower plate that extends radially inwardly from a lower end of the inner circumferential wall. A guide rail, engaged with the gear to guide rotation of the discharge guider, may be formed on a lower surface of the lower plate, such that the discharge guider may be rotated through the lower plate, and the discharge grill may be disposed between the outer circumferential wall and the inner circumferential wall which form an annular shape.

A first bearing, that rotates while in contact with one side of the discharge body, may be disposed on an upper surface of the lower plate, thereby inducing the discharge guider to rotate stably. A stopper, that protrudes upward from the lower plate and restricts a rotational range of the discharge guider, may be disposed on an upper side of the lower plate, thereby restricting the rotational range of the discharge guider.

The discharge body may include a mounting part or mounts that extends radially outward from an upper end of the outer body. The discharge guider may be partially disposed on an upper side of the mounting part, such that the discharge guider may be rotatably mounted on the upper side of the discharge body. The mounting part may have a bearing groove in which a second bearing, that comes into contact with the outer circumferential wall of the discharge guider, may be disposed, such that the discharge guider disposed on the discharge body may rotate stably.

Embodiments disclosed herein provide an air cleaner that may include a first blower that discharges air to a discharge port formed on an upper side; a second blower disposed over the first blower and that discharges air to a discharge port formed on an upper side; and a divider disposed between the first blower and the second blower, and vertically separating the first blower and the second blower, such that the air cleaner may flow the air through the first blower and the second blower. The first blower disposed at a lower position may include a case having a discharge port which is formed on an upper side and is vertically open; a fan disposed inside of the case, and that blows air inside the case toward the discharge port; a discharge body disposed on an upper side of the case in which the discharge port is formed, and having a discharge passage that guides air, blown by the fan, toward the discharge port; a discharge guider rotatably disposed on an upper side of the discharge body, and having a plurality of grills bent so as to guide air, flowing upward through the discharge passage, in a radially outward direction; and a motor that rotates the discharge guider disposed on the discharge body, thereby inducing the air, discharged upward from the first blower, to flow in one direction. The divider may include a guide wall that extends rounded in a radial direction, and a lower end fixing wall that extends downwardly from the guide wall and coupled to the discharge body, such that the lower end fixing wall may be fixedly disposed in the discharge body, and the air blown by the first blower may be prevented from flowing to the second blower.

The discharge guider may include an outer circumferential wall that forms an outer circumference; an inner circumferential wall spaced apart radially inward from the outer circumferential wall; a plurality of discharge grills disposed between the outer circumferential wall and the inner circumferential wall, and bent so as to change a wind direction of upwardly flowing air; and a lower plate that extends radially inward from a lower end of the inner circumferential wall. A guide rail, engaged with the gear to guide rotation of the discharge guider, may be formed on a lower surface of the lower plate; and a first bearing, that rotates while in contact with an outer circumferential surface of the lower end fixing wall, may be disposed on an upper surface of the lower plate, such that the discharge guider disposed on the upper side of the first blower may rotate stably without being in contact with the divider. A stopper, that protrudes upward from the lower plate and coming into contact with a portion of the divider to restrict a rotational range of the discharge guider, may be disposed on an upper side of the lower plate, such that the divider may restrict a rotational range of the discharge guider.

The air cleaner may further include a circulator movably disposed on an upper side of the second blower and controlling a wind direction of air discharged from the second blower, thereby separately controlling a wind direction of air discharged from the first blower and a wind direction of air discharged from the second blower.

An air cleaner according to embodiments disclosed herein has one or more of the following advantages.

By using a discharge guider rotatably mounted on the discharge body having a discharge passage which is vertically open, a flow direction of upwardly discharged air may be easily changed. Further, by providing a motor and a gear in an inner space of the discharge body, and securing a space for mounting a guide rail of the discharge guider above a position where the gear is disposed, a product may be manufactured in a spatially compact manner. Accordingly, by using the discharge guider and a structure for rotating the same, a wind direction of air may be changed without interrupting the flow of air flowing through an annular discharge passage.

By providing a discharge guider which is rotatably mounted on the discharge body having a discharge passage that guides air flow in an upward direction and guides the upwardly flowing air in one direction, a wind direction of the upwardly flowing air may be controlled so that filtered air may flow to an area desired by a user, thereby rapidly improving comfort in a room. That is, by minimizing an amount of air discharged to a blind spot area in which air purification is not required, purified air may be intensively discharged to an area requiring air purification.

A first blower is disposed under the second blower, such that it is difficult to control a wind direction of air discharged from the first blower. However, in embodiments disclosed herein, the annular discharge guider rotates on an upper side of the discharge body, and a plurality of bent grills is disposed, such that the upwardly discharge air may flow a long distance. By separately controlling a wind or flow direction of air discharged from the first blower and a wind or flow direction of air discharged from the second blower, a user's needs may be satisfied.

Embodiments disclosed herein are not limited to the aforesaid advantages, and other advantages not described herein will be clearly understood by those skilled in the art from the description and appended claims.

While embodiments have been particularly shown and described, it will be understood by those skilled in the art that the embodiments are not limited to those exemplary embodiments and various changes in form and details may be made therein without departing from the scope and spirit as defined by the appended claims and should not be individually understood from the technical spirit or prospect.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air cleaner, comprising:
a case having a circular cross section and extending in a vertical direction, the case having a discharge port which is formed at an upper side and is vertically open;
a fan disposed inside of the case; and
a discharge guider disposed at the discharge port, and having a plurality of grills extending in a width of the case and arranged parallel to each other.

2. The air cleaner of claim 1, wherein the grills are tilted with respect to a longitudinal direction of the case.

3. The air cleaner of claim 1, wherein an upper part of the grills extends along a direction tilted with respect to the longitudinal direction of the case.

4. The air cleaner of claim 1, wherein the grills are bent along a first direction perpendicular to the vertical direction and are spaced apart from each other in the first direction.

5. The air cleaner of claim 1, wherein a distance between two adjacent grills among the plurality of grills is narrower at an upper side than at the lower side.

6. The air cleaner of claim 1, wherein the grill has a leading edge forming a lower end of the grill and a trailing edge forming a upper end of the grill, and
wherein a thickness of the trailing edge is greater than a thickness of the leading edge.

7. The air cleaner of claim 1, further comprising a discharge body disposed on an upper side of the case and providing a discharge passage communicating with the discharge port,
wherein the discharge body comprises:
an outer body defining an outer circumference of the discharge passage; and
an inner body disposed radially inward from the outer body, and
wherein the discharge passage is located between the outer body and the inner body and has an annular shape.

8. The air cleaner of claim 7, wherein the discharge guider is dispose on the discharge body.

9. The air cleaner of claim 8, further comprising a motor configured to rotate the discharge guider,
wherein the discharge guider is configured to be rotated about a rotation axis parallel to the longitudinal direction of the case.

10. The air cleaner of claim 9, further comprising a gear that rotates while being coupled to the motor, wherein the motor is mounted in the discharge body, and the discharge guider comprises a guide rail disposed inside of the inner body and engaged with the gear.

11. The air cleaner of claim 10, wherein the guide rail is formed in a ring shape on a lower surface of the discharge guider.

12. The air cleaner of claim 11, wherein the gear comprises a bevel gear that rotates about a rotational axis perpendicular to a rotational axis of the discharge guider, and has a conical shape.

13. The air cleaner of claim 10, wherein the discharge guider comprises:
an outer circumferential wall that forms an outer circumference thereof;
an inner circumferential wall spaced apart radially inwardly from the outer circumferential wall; and
a lower plate that extends radially inward from a lower end of the inner circumferential wall,
wherein the plurality of discharge grills are disposed between the outer circumferential wall and the inner circumferential wall, and
wherein a guide rail, engaged with the gear to guide rotation of the discharge guider, is formed on a lower surface of the lower plate.

14. The air cleaner of claim 13, further comprising a guide wall disposed above the discharge guider and extends upwardly such that a width of an upper part of the guide wall is bigger than a width of a lower part of the guide wall,
wherein the discharge body comprises a fixing body disposed inside of the inner body and coupled to a lower part of the guide wall, and
wherein a first bearing, that rotates while in contact with the fixing body, is disposed on an upper surface of the lower plate.

15. The air cleaner of claim 13, wherein a stopper that protrudes upward from the lower plate and restricts a rotational range of the discharge guider.

16. The air cleaner of claim 9, wherein the discharge body comprises a mount that extends radially outward from an upper end of the outer body, and wherein the discharge guider is partially disposed on an upper side of the mount.

17. The air cleaner of claim 16, wherein the mount has a bearing groove in which a second bearing, configured to contact the outer circumferential wall of the discharge guider, is disposed.

18. The air cleaner of claim 7, further comprising a guide wall disposed at an upper side of the discharge body and that extends radially outward from the discharge body in an upward direction.

19. The air cleaner of claim 18, wherein the discharge body comprises a fixing body spaced apart inwardly from the inner body, and
wherein a lower part of the guide wall is fixed to the fixing body.

20. The air cleaner of claim 19, wherein the discharge body comprises a connection plate that connects the fixing body and the inner body, and wherein the connection plate is disposed below an upper end of the inner body.

21. The air cleaner of claim 20, further comprising a motor mounted at the discharge body and configured to rotate the discharge guider; and
a gear that rotates while being coupled to the motor,
wherein the discharge guider comprises a guide rail formed in a ring shape on a lower surface of the discharge guider and engaged with the gear, and wherein the guide rail is inserted into a space between the inner body and the fixing body.

22. The air cleaner of claim 21, wherein the discharge body comprises a motor sheet disposed inside of the fixing body and that fixes an arrangement of the motor.

23. The air cleaner of claim 9, further comprising a gear that rotates while being coupled to the motor, wherein the motor is mounted on the discharge guider, and a guide rail engaged with the gear is formed on the discharge body.

24. An air cleaner, comprising:
a first blower having a first discharge port formed on an upper side thereof;
a second blower disposed over the first blower and having a second discharge port formed on an upper side thereof; and
a divider disposed between the first blower and the second blower and that vertically separates the first blower and the second blower, wherein the first blower comprises:
a case extending in a vertical direction, the case having the first discharge port which is formed on an upper side thereof and is vertically open;
a fan disposed inside of the case; and
a discharge guider disposed at the discharge port, and having a plurality of grills extending in a width of the case and arranged parallel to each other,
wherein the divider including a guide wall forming a lower part of the divider, and
wherein the guide wall is disposed above the discharge guider and extends upwardly such that a width of an upper part of the guide wall is bigger than a width of a lower part of the guide wall.

25. The air cleaner of claim 24, wherein the divider comprises:
a lower end fixing wall that extends downwardly from the guide wall and coupled to the discharge body.

26. An air cleaner, comprising:
a case having a discharge port which is formed at an upper side and is vertically open;
a fan disposed inside of the case, and causing air inside the case to flow toward the discharge port;
a discharge body disposed on an upper side of the case in which the discharge port is formed, and having a discharge passage that guides air, blown by the fan, toward the discharge port; and
a discharge guider rotatably disposed on an upper side of the discharge body, and having a plurality of grills angled so as to guide air, flowing upward through the discharge passage, in a radially outward direction, wherein the discharge guider comprises:
an outer circumferential wall that forms an outer circumference thereof;
an inner circumferential wall spaced apart radially inwardly from the outer circumferential wall; and
the plurality of discharge grills, which is disposed between the outer circumferential wall and the inner circumferential wall and angled so as to change a flow direction of upwardly flowing air.

27. The air cleaner of claim 26, wherein the plurality of grills is spaced apart from each other in a direction perpendicular to a vertical direction and is curved to one side in the direction in which the plurality of grills is spaced apart from each other.

28. The air cleaner of claim 26, wherein the plurality of grills is spaced apart from each other in a direction perpendicular to a vertical direction and is slanted to one side in the direction in which the plurality of grills is spaced apart from each other.

29. The air cleaner of claim 26, wherein the plurality of grills is spaced apart from each other in a direction perpendicular to a vertical direction and includes a first portion extending in the vertical direction and a second portion curved to one side in the direction in which the plurality of grills is spaced apart from each other.
